(19) United States
(12) Patent Application Publication
(10) Pub. No.: US 2013/0184997 A1
(43) Pub. Date: Jul. 18, 2013

(54) Task-Modulated Neurobehavioral Status

(71) Applicant: Christopher Grey Mott, Seattle, WA (US)

(72) Inventor: Christopher Grey Mott, Seattle, WA (US)

(73) Assignee: Pulsar Informatics, Inc., Philadelphia, PA (US)

(21) Appl. No.: 13/548,190

(22) Filed: Jul. 12, 2012

Related U.S. Application Data
(60) Provisional application No. 61/506,969, filed on Jul. 12, 2011.

(51) Int. Cl. G06F 19/00

(52) U.S. Cl. CPC G06F 19/3487
USPC 702/19

(57) ABSTRACT

Systems and methods for modulating a subject's neurobehavioral status by a task-dependent arousal index are provided. Neurobehavioral status may be measured or model-predicted, and the arousal index reflects the composite effect on the subject's neurobehavioral performance of behavioral, environmental, psychological, and physiological factors of the subject's performing an assigned task. Task arousal index may be selected from a database, provided by user input, or combined in real time from sensor data.

### RELATED APPLICATIONS

This application claims benefit of the priority of U.S. application No. 61/506,969, filed Jul. 12, 2011.

### TECHNICAL FIELD

The presently disclosed systems and methods relate to systems, methods, and/or devices for predicting neurobehavioral status or performance, including fatigue and/or alertness states, of a human subject. The presently disclosed invention adjusts or modulates a predicted neurobehavioral status level based upon certain parameters, conditions, or variables related to a designated task being performed by the subject. These parameters relate to the environmental conditions in which the task is to be performed (e.g., heat, humidity, wind, movement, vibration, etc.), the behavioral characteristics of the subject's performance of the task (e.g., physical exertion required, movements required, etc.), and the physiological and psychological impact on the subject of performing the task (e.g., heart rate, blood pressure, ECG data, mood, anxiety level, etc.).

### BACKGROUND

The ad hoc management of detrimental neurobehavioral states, such as (without limitation) a state of alertness deficit (also called “fatigue state”), can be deleterious for certain operational objectives. Problems of adjusting the neurobehavioral status of a particular subject (e.g., employee, warfighter, pilot, driver, ship captain, lab technician, astronaut, etc.) so as to take into effect the demands of a particular designated task (e.g., driving versus working at a computer) may cause poor judgments in the management of neurobehavioral status of particular populations. Some tasks may not be suitable for performance at all neurobehavioral status levels, and particular tasks may, in fact, decidedly alter the neurobehavioral status of the subject performing them. There is therefore a long-felt need for systems, methods, and techniques to modulate a neurobehavioral performance estimate based upon the unique characteristics of a task being performed by the subject so as to account for the neurobehavioral impact of the task on said subject.

### SUMMARY

Particular embodiments of the presently disclosed invention assist operational managers and/or other users to predict, and to modulate the prediction of, the neurobehavioral status of a testing subject while the testing subject is performing a designated task. One particular aspect of the presently disclosed invention provides a method for determining with a computer a task-modulated neurobehavioral status estimate based upon a subject's task-independent neurobehavioral status estimate and a task-arousal index, the method comprising: receiving at the computer a neurobehavioral status estimate, the neurobehavioral status estimate being indicative of the neurobehavioral status of a subject under a set of external conditions irrespective of a task being performed; determining, at the computer, a task-arousal index, the task-arousal index being indicative of the neurobehavioral impact related to the subject performing a designated task; and determining a task-modulated neurobehavioral status estimate based at least in part on the received neurobehavioral status estimate and the determined task-arousal index, the task-modulated neurobehavioral status estimate being indicative of the neurobehavioral status of the individual while performing the designated task.

A computer program product embodied in a non-transitory medium and comprising computer-readable instructions that, when executed by a suitable computer, cause the computer to perform a method for determining a task-modulated neurobehavioral status estimate based upon a subject's task-independent neurobehavioral status estimate and a task-arousal index, the method comprising: receiving at the computer a neurobehavioral status estimate, the neurobehavioral status estimate being indicative of the neurobehavioral status of a subject under a set of external conditions irrespective of a task being performed; determining, at the computer, a task-arousal index, the task-arousal index being indicative of the neurobehavioral impact related to the subject performing a designated task; and determining a task-modulated neurobehavioral status estimate based at least in part on the received neurobehavioral status estimate and the determined task-arousal index, the task-modulated neurobehavioral status estimate being indicative of the neurobehavioral status of the individual while performing the designated task.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic illustration of a system for determining a task-modulated neurobehavioral status estimate, in accordance with particular embodiments;

FIG. 2A is a flowchart illustrating a method 200A for determining a task-modulated neurobehavioral status estimate, in accordance with particular embodiments;

FIG. 2B is flowchart illustrating a method 200B for determining a received task arousal index in accordance with step 202 of method 200A, in accordance with particular embodiments;

FIGS. 3A and 3B show plots of a neurobehavioral status estimate over time, and a task-modulated neurobehavioral status estimate over time, respectively, in accordance with particular embodiments;

FIG. 4 is a plot showing the variation of the homeostatic process of a typical subject over the transitions between being asleep and awake, in accordance with particular embodiments; and

FIG. 5 is a graph illustrating the Yerkes-Dodson Law, in accordance with particular embodiments.

### DETAILED DESCRIPTION

Throughout the following discussion, specific details are set forth in order to provide a more thorough understanding of the disclosed invention. The invention, however, may be practiced without these particulars. In other instances, well-known elements have not been shown or described in detail to avoid unnecessarily obscuring the invention. Accordingly, the specification and drawings are to be regarded in an illustrative capacity, rather than in a restrictive sense.

Background to Neurobehavioral Performance

Aspects of the presently disclosed invention relate to various features and details of neurobehavioral performance. Broadly defined, “neurobehavioral performance” refers to an individual's ability to perform a specific task that requires one or more cognitive functions that rely on alertness level and/or fatigue state. Such cognitive functions include (without limitation) concentration, short-term or long-term memory, visual or other sensory acuity, alertness, gross motor dexterity, fine motor skill, and/or the like. As used herein, the terms (used interchangeably) “neurobehavioral performance prediction(s),” “predicted neurobehavioral performance,” and “predicted neurobehavioral performance level(s)” refer to the output of a biomathematical model capable of modeling and/or predicting neurobehavioral performance states when given appropriate inputs. Non-limiting factors that may impact a subject's neurobehavioral performance include: sleep disruption, sleep restriction, circadian misalignment, sleep inertia, extended task performance, extended work/duty hours, multitasking, (extended) physical exertion, psychological stresses (e.g., time pressure; family, financial, or legal issues etc.), environmental stressors (e.g., extreme temperature or humidity conditions, ambient noise, ambient vibration, ambient light conditions, altitude “hypoxia” etc.), certain medical conditions or behavioral disorders (e.g., Parkinson's, Alzheimer's, dementia, or any age-related brain dysfunction or mild cognitive impairment, brain injuries, mood disorders, and certain psychoses, etc.).

Methods to Test Neurobehavioral Performance Generally

The presently disclosed invention may make use of any methods or techniques used to measure neurobehavioral performance. Such methods and techniques may include context-relative performance tasks, such as a workplace-specific task (e.g., assembling X number of specific product units in a particular factory in time T and/or the like), standardized line-of-work specific tasks (e.g., typing a standard document within an acceptable accuracy threshold on standard equipment, and/or the like), and so-called “special tasks” that highlight particular neurobehavioral performance characteristics (e.g., executing a specific complex driving, flying, or navigation maneuver within an acceptable threshold, navigating a standardized obstacle course on foot, assembling a particular standardized complex manufactured object, and/or the like). Performance measures for such neurobehavioral tasks may come from direct human observation, measurement instruments, or from embedded systems. Furthermore, performance assessment on one or more neurobehavioral tasks may be measured by one or more standard tests including but not limited to: the Psychomotor Vigilance Test (PVT), the Motor Praxis Test (MPraxis), the Visual Object Learning Test (VOLT), the Fractal-2-Back Test (F2B), the Conditional Exclusion Task (CET), the Matrix Reasoning Task (MRsT), the Line Orientation Test (LOT), the Emotion Recognition Task (ER), the Balloon Analog Risk Task (BART), the Digit Symbol Substitution Test (DSST), the Forward Digit Span (FDS), the Reverse Digit Span (BDS), the Serial Addition and Subtraction Task (SAST), the Go/NoGo Task, the Word-Pair Memory Task, the Word Recall Test (Learning, Recall), the Motor Skill Learning Task, the Threat Detect Task, the Descending Subtraction Task (DST), the Positive Affect Negative Affect Scales—Extended version (PANAS-X) Questionnaire, the Pre-Sleep/Post-Sleep Questionnaires for astronauts, the Beck Depression Inventory (BDI), the Conflict Questionnaire, Karolinska Drowsiness Test (KDT), the Visual Analog Scales (VAS), the Karolinska Sleepiness Scale (KSS), the Profile of Mood States Long/Short Form Questionnaire (POMS/POMS SF), the Stroop Test, and/or the like.

Methods to Test Fatigue Specifically

Although the presently disclosed invention may be used to modulate a subject's neurobehavioral performance status generally, particular embodiments are specifically directed to the modulation of a subject's fatigue or alertness state. (As used herein the terms “alertness” and “fatigue” shall refer to the same neurobehavioral characteristic, but from “opposite” or reciprocal perspectives—i.e., alertness a is the reciprocal of fatigue f—i.e. a≈1/f.) Embodiments of the presently disclosed invention may make use of one or more techniques for measuring or testing an individual's alertness or fatigue levels (referred to hereinafter as “fatigue-measurement techniques”). Particular embodiments of the invention are sufficiently adaptable to utilize many (if not all) of these known fatigue-measurement techniques. Non-limiting and non-mutually exclusive examples of suitable fatigue-measurement techniques which may be used in various embodiments of the invention include testing techniques which use: (i) objective reaction-time tasks, stimulus-response tests, and cognitive tasks such as the Psychomotor Vigilance Task (PVT) or variations thereof (Dinges, D. F. and Powell, J. W. “Microcomputer analyses of performance on a portable, simple visual RT task during sustained operations” Behavior Research Methods, Instruments, & Computers 17(6): 652-655, 1985) and/or a so-called digit symbol substitution test; (ii) subjective alertness, sleepiness, or fatigue measures based on questionnaires or scales such as (without limitation) the Stanford Sleepiness Scale, the Epworth Sleepiness Scale (Jons, M. W., “A new method for measuring daytime sleepiness—the Epworth sleepiness scale” Sleep 14 (6): 54-545, 1991), and the Karolinska Sleepiness Scale (Akerstedt, T. and Gillberg, M. “Subjective and objective sleepiness in the active individual” International Journal of Neuroscience 52: 29-37, 1990); (iii) EEG measures and sleep-onset-tests including (without limitation) the Karolinska drowsiness test (Akerstedt, T. and Gillberg, M. “Subjective and objective sleepiness in the active individual” International Journal of Neuroscience 52: 29-37, 1990), Multiple Sleep Latency Test (MSLT) (Carskadon, M. W. et al., “Guidelines for the multiple sleep latency test—A standard measure of sleepiness” Sleep 9 (4): 519-524, 1986) and the Maintenance of Wakefulness Test (MWT) (Mitler, M. M., Gujavarty, K. S. and Browman, C. P., “Maintenance of Wakefulness Test: A polysomnographic technique for evaluating treatment efficacy in patients with excessive somnolence” Electroencephalography and Clinical Neurophysiology 53:658-661, 1982); (iv) physiological measures such as (without limitation) tests based on blood pressure and heart rate changes, and tests relying on pupillography and/or electrodermal activity (Canisius, S. and Penzel, T., “Vigilance monitoring—review and practical aspects” Biomedizinische Technik 52(1): 77-82., 2007); (v) embedded performance measurement systems, devices, and processes such as (without limitation) devices that are used to measure a driver's performance in tracking the lane marker on the road (see, e.g., U.S. Pat. No. 6,894,606); and (vi) simulators that provide a virtual environment to measure specific task proficiency such as commercial airline flight simulators (Neri, D. F., Oyung, R. L., et al., “Controlled breaks as a fatigue countermeasure on the flight deck” Aviation Space and Environmental Medicine 73(7): 654-664, 2002); and/or (vii) the like. Particular embodiments of the invention may make use of any one or more of the fatigue-measurement techniques described in the aforementioned references or various combinations and/or equivalents thereof. All of the publications referred to in this paragraph are hereby incorporated by reference herein.

Models for Predicting Neurobehavioral Performance

The presently disclosed invention is designed to utilize any biomathematical model designed generally to model any one or more of human subject's neurobehavioral performance characteristics. Such biomathematical models are referred to herein as “neurobehavioral performance models.” Particular embodiments are specifically designed to utilize biomathematical models that model a human subject's alertness and/or fatigue state. Such biomathematical models are referred to herein as “fatigue models.” As used herein, the terms “biomathematical model(s),” “neurobehavioral performance model(s),” and “fatigue model(s)” shall have the following relationship: fatigue models are a subset of neurobehavioral performance models (fatigue and/or alertness being a type of neurobehavioral performance), and neurobehavioral performance models are, in turn, a subset of biomathematical models.

Among the neurobehavioral performance models utilized by the presently disclosed invention, particular embodiments may utilize the so-called “two-process model” of sleep regulation developed by Borbély et al. in 1999. The Borbély two-process model posits the existence of two primary regulatory mechanisms: (i) a sleep/wake-related mechanism that builds up exponentially during the time that the subject is awake and declines exponentially during the time that the subject is asleep, and is called the “homeostatic process” or “process S;” and (ii) an oscillatory mechanism with a period of (nearly) 24 hours, called the “circadian process” or “process C.” Without wishing to be bound by theory, the circadian process has been demonstrated to be orchestrated by the suprachiasmatic nuclei of the hypothalamus. The neurobiology of the homeostatic process is only partially known and may involve multiple neuroanatomical structures. Total alertness at a given time y(t), which is one non-limiting example of neurobehavioral performance, may then be represented as a sum of the C and S processes (see Equation 3, below).

Further details of the Borbély two-process fatigue model are contained in PCT published patent application Systems and Methods for Individualized Alertness Predictions, inventors Mott C. G., Mollicone, D. J., et al., WIPO publication No. WO 2009/052633, the entirety of which is incorporated herein by reference and from which portions of the following discussion are excerpted for convenience and clarity.

Specifically, in accordance with the two-process model, the circadian process C may be represented by:

$$C ( t ) = γ {\sum }_{l = 1}^{5} {a}_{l} sin ( 2 l π ( t - ϕ ) / τ ) \qquad ( 1 )$$

where t denotes clock time (in hours, e.g. relative to midnight), φ represents the circadian phase offset (i.e. the timing of the circadian process C relative to clock time), γ represents the circadian amplitude, and τ represents the circadian period which may be fixed at a value of approximately or exactly 24 hours. The summation over the index l serves to allow for harmonics in the sinusoidal shape of the circadian process. For one particular application of the two-process model for alertness prediction, l has been taken to vary from 1 to 5, with constants a₁ being fixed at a₁=0.97, a₂=0.22, a₃=0.07, a₄=0.03, and a₅=0.001.

The homeostatic process S may be represented by:

$$S ( t ) = \{ \begin{matrix}{e}^{- {ρ}_{w} Δ t} {S}_{t - Δ t} + ( 1 - {e}^{- {ρ}_{w} Δ t} ) & if during wakefulness \\ {e}^{- {ρ}_{w} Δ t} {S}_{t - Δ t} & if during sleep\end{matrix} \qquad \begin{matrix}( 2 a ) \\ ( 2 b )\end{matrix}$$

(S>0), where t denotes (cumulative) clock time, Δt represents the duration of time step from a previously calculated value of S, ρ_{w} represents the time constant for the build-up of the homeostatic process during wakefulness, and ρₛ represents the time constant for the recovery of the homeostatic process during sleep.

Given equations (1), (2a) and (2b), the total alertness according to the two-process model may be expressed as a sum of: the circadian process C, the homeostatic process S multiplied by a scaling factor κ, and an added noise component ε(t):

y(t)=κS(t)+C(t)+ε(t) (3)

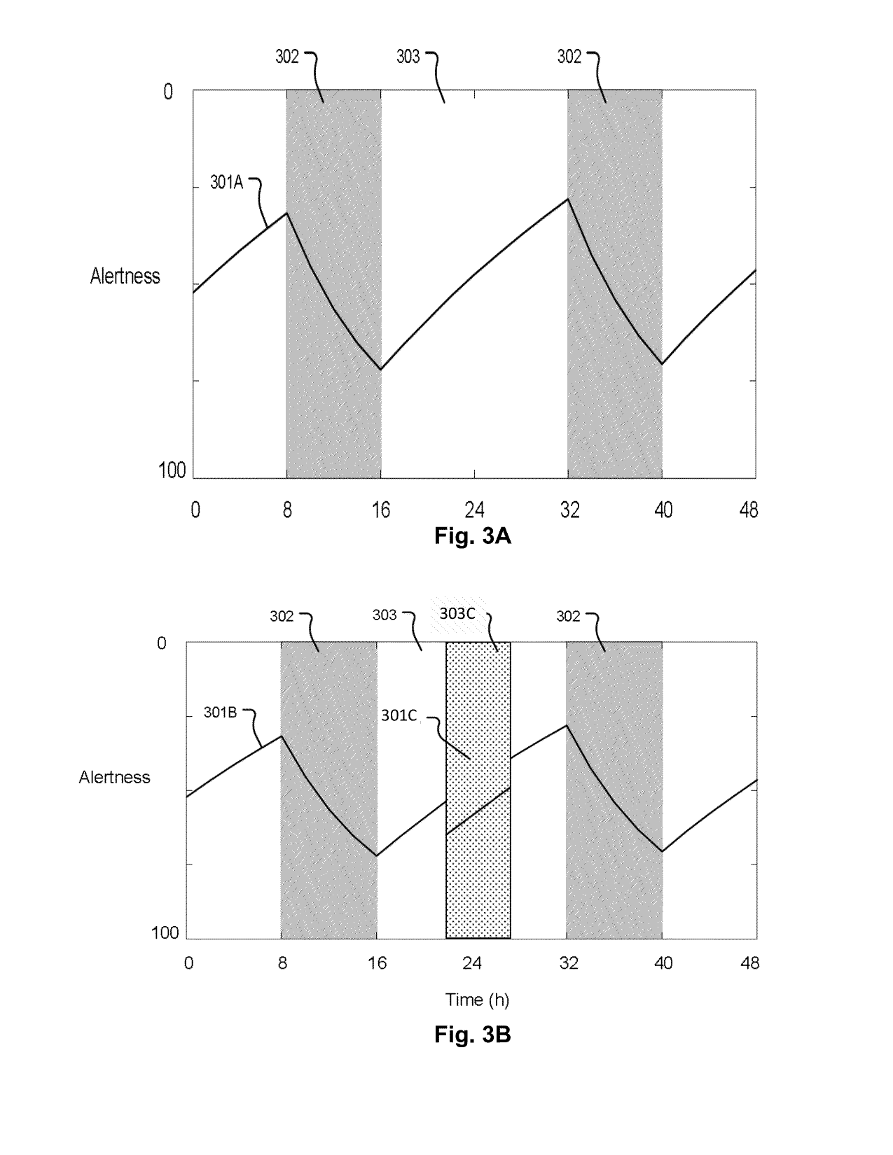

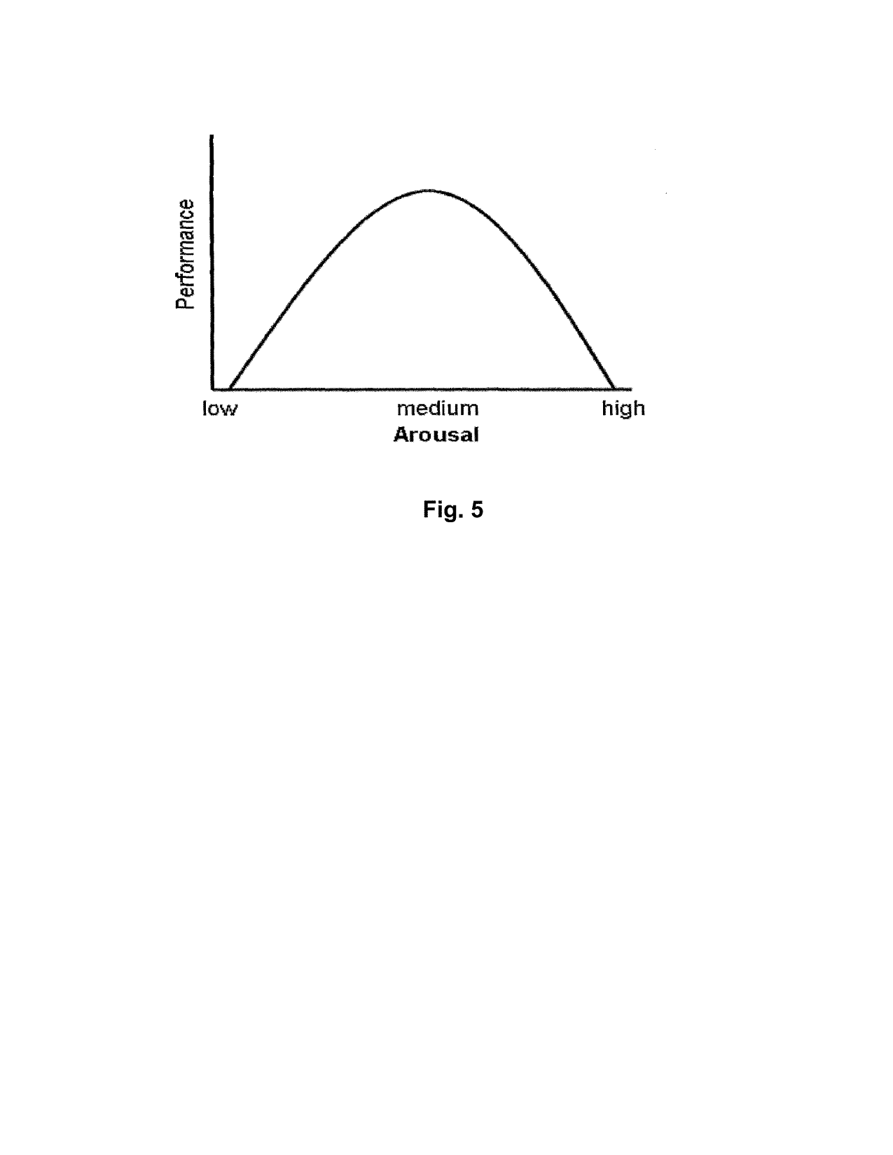

Furthermore, it is useful to be able to describe the homeostatic process S for test subject after one or more transitions between being asleep and being awake. The sleep-wake transitions are commonly (but without limitation) represented as square wave signals oscillating between the binary states of being asleep (value=1 herein, without limitation) and being awake (value=0 herein, without limitation), referred to as sleep functions. As discussed in connection with FIG. 3B, other mathematical representations of sleep status and effectiveness can be utilized by the presently disclosed invention. FIG. 3A and the multiple views of FIG. 5, furthermore, illustrate several ways in which a binary sleep function may be modified to adequately reflect a subject's apnea severity by inserting one or more wake episodes in the form of slender “notches” in a square wave signal.

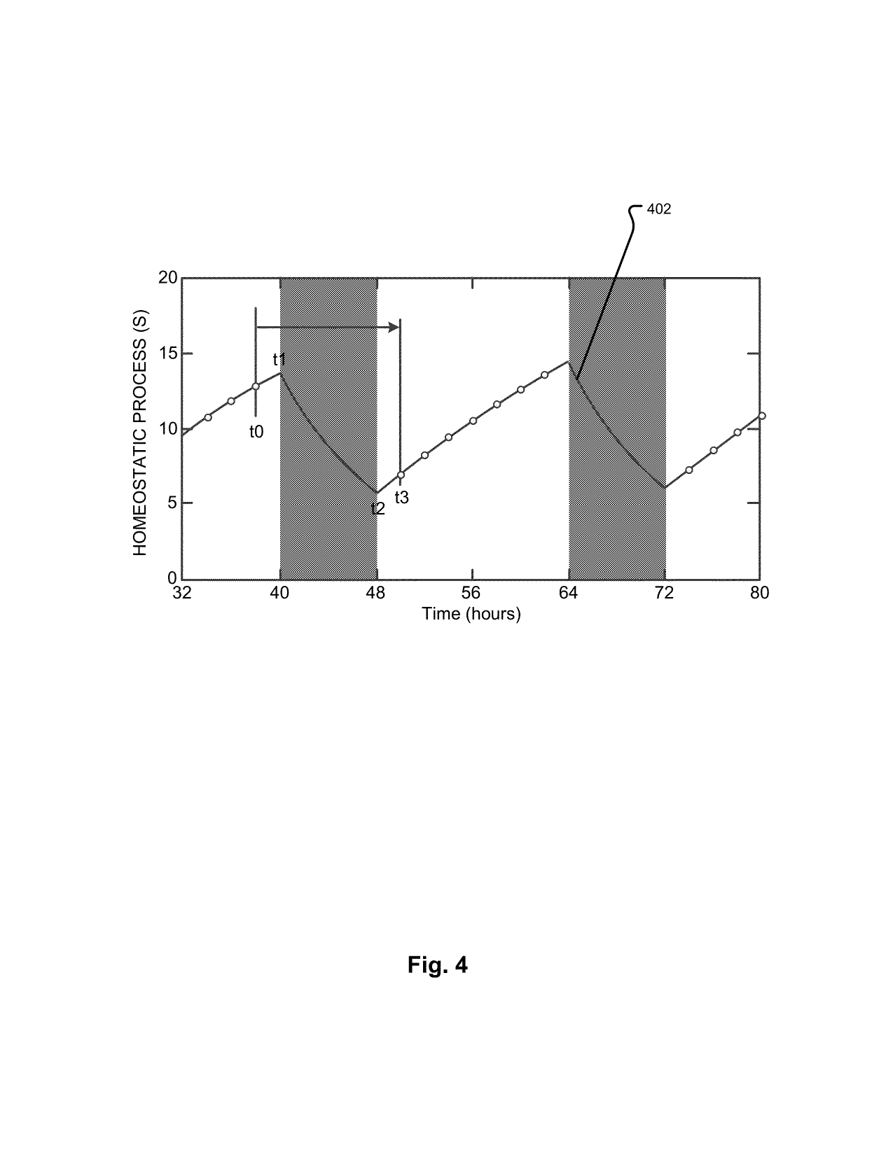

As described in more particular detail below, the systems and methods of the invention may make use of measured neurobehavioral performance levels which is typically only available when the subject is awake. Consequently, it may be desirable to describe the homeostatic process between successive periods that the test subject is awake. As the circadian process C is independent from the homeostatic process S, we may consider as an illustrative case of neurobehavioral performance using only the homeostatic process S of equations (2a), (2b). Consider the period between t₀ and t₃ shown in FIG. 4. During this period, the subject undergoes a transition from awake to asleep at time t₁ and a transition from asleep to awake at time t₂. Applying the homeostatic equations (2a), (2b) to the individual segments of the period between t₀ and t₃ yields:

S(t₁)=S(t₀)e^{-ρ}^{_{w}}^{T}^{₁}+(1−e^{-ρ}^{_{w}}^{T}^{₁}) (4a)

S(t₂)=S(t₁)e^{-ρ}^{ₛ}^{T}^{₂} (4b)

S(t₃)=S(t₂)e^{-ρ}^{_{w}}^{T}^{₃}+(1−e^{-π}^{_{w}}^{T}^{₃}) (4c)

where

T₁=t₁−t₀ (5a)

T₂=t₂−t₁ (5b)

T₃=t₃−t₂ (5c)

Substituting equation (5a) into (5b) and then (5b) into (5c) yields an equation for the homeostat at a time t₃ as a function of an initial known homeostat condition S(t₀), the time constants of the homeostatic equations (ρ_{w}, ρₛ) and the transition durations (T_{I}, T₂, T₃):

$$S ( {t}_{3} ) = fs ( S ( {t}_{0} ) , {ρ}_{w} , {ρ}_{x} , {T}_{1} , {T}_{2} , {T}_{3} ) = [ S ( {t}_{0} ) {e}^{- {ρ}_{w} {T}_{1}} + ( 1 - {e}^{- {ρ}_{w} {T}_{1}} ) ] {e}^{- {ρ}_{1} {T}_{1} - {ρ}_{w} {T}_{3}} + ( 1 - {e}^{- {ρ}_{w} {T}_{3}} ) \qquad ( 6 )$$

Equation (6) applies to the circumstance where t₀ occurs during a period when the test subject is awake, there is a single transition between awake and asleep at t₁ (where t₀<t₁<t₃), there is a single transition between asleep and awake at t₂ (where t₁<t₂<t₃), and then t₃ occurs after the test subject is awake again.

Additional fatigue models may be utilized by particular embodiments. Other non-limiting examples of fatigue models include Akerstedt's “three-process model of alertness” (see, e.g., Akerstadt, T., et al. “Predictions from the Three-Process Model of Alertness,” Aviation, Space, and Environmental Medicine, 75:No. 3, §II (March 2004); see also Akerstedt, T. et al. “A Model of Human Sleepiness,” excerpted from Sleep '90 J. Horne, Ed. (Pontenagel Press 1990)); Achermann's “two-process model revisited” (see e.g., Achermann, P., “The Two-Process Model of Sleep Regulation Revisited,” Aviation, Space, and Environmental Medicine, 75:No. 3, §II (March 2004)); Avinash's “process-U model” (see Avinash, D., “Parameter Estimation for a Biomathematical Model of Psychomotor Vigilance Performance under Laboratory Conditions of Chronic Sleep,” Sleep-Wake Research in the Netherlands 16:39-42 (Dutch Society for Sleep-Wake Research 2005); Beersma's “modified two-process model” (see, e.g., Beersma, D. G. M., “Models of Human Sleep Regulation,” Sleep Medicine Reviews 2:No. 1, pp. 31-43 (W.B. Saunders Co. Ltd. 1998)); Belyavin and Spencer's “QinetiQ Approach” (see, e.g., Belyavin, A. J. and Spencer, M. B., “Modeling Performance and Alertness: the QinetiQ Approach,” Aviation, Space, and Environmental Medicine, 75:No. 3, §II (March 2004)); the “circadian alertness simulator” (see, e.g., Dijk, D. J., et al. “Fatigue and Performance Models: General Background and Commentary on the Circadian Alertness Simulator for Fatigue Risk Assessment in Transportation,” Aviation, Space, and Environmental Medicine, 75:No. 3, §II (March 2004)); the so-called “new model class” (see, e.g., McCauley, P., et al, “A new mathematical model for the homeostatic effects of sleep loss on neurobehavioral performance,” Journal of Theoretical Biology, 256:227-239 (Reed-Elsevier 2009)); alternative models such as nonparametric approaches and neural networks (see, e.g., Reifman, J., “Alternative Methods for Modeling Fatigue and Performance,” Aviation, Space, and Environmental Medicine, 75:No. 3, §II (March 2004)); and/or the like. Particular embodiments of the presently disclosed invention may make use of any one or more of the biomathematical models described in the aforementioned references or various combinations and/or equivalents thereof. All of the publications referred to in this paragraph are hereby incorporated by reference herein.

The presently disclosed invention may utilize one or more of the foregoing biomathematical models to predict neurobehavioral performance levels when certain inputs are provided. Particular embodiments may focus on fatigue and/or alertness as the specific neurobehavioral characteristic being measured and/or assessed.

Background to Arousal State

As used in the present discussion and the appended claims, the term “arousal” refers to the activation state and/or the activation energy of an organism's autonomic nervous system. The autonomic nervous system controls many physiological processes not consciously controlled by the brain and is responsible for many features of neurobehavioral performance. The classic description of the relationship between arousal and neurobehavioral performance is the Yerkes-Dodson law (Yerkes and Dodson, 1908). This empirically based law, which was originally demonstrated using mice, dictates that neurobehavioral performance increases with cognitive arousal, but only to a certain point: when levels of arousal become too high, neurobehavioral performance will decrease. A corollary is that there is an optimal level of arousal for a given task. The process is often demonstrated graphically as an inverted U-shaped curve (see FIG. 5), increasing and then decreasing with higher levels of arousal. It has been proposed that different tasks may require different levels of arousal. For example, difficult or intellectually demanding tasks may require a lower level of arousal for optimal performance (to facilitate concentration), whereas tasks demanding stamina or persistence may be performed better with higher levels of arousal (to increase motivation). The effect of the difficulty of tasks later on led to the hypothesis that the Yerkes-Dodson Law can be decomposed into two distinct factors. The upward part of the converted U can be thought of as the energizing effect of arousal. The downward part on the other hand is caused by negative effects of arousal (or stress) on cognitive processes, like attention (“tunnel vision”), memory, and problem-solving.

From the Yerkes-Dodson law, it follows that it would be beneficial to monitor and control arousal to facilitate or enhance task performance. Multiple variables indicative of arousal are known in the art (e.g. EEG, heart rate, skin conductance, etc.). These indices of arousal however are not only influenced by arousal. Total heart rate for instance is composed of heart rate required for basal metabolism, for mechanical activity, for heat balance, as well as for arousal. In practice, arousal will be measured in two conditions: in (resting) subjects as such, and in (resting) subjects subjected to conditions increasing arousal. The differences between the two settings are then attributed to (physiological) arousal, the other components attributing to the index of arousal (such as mechanical activity, basal metabolism and heat balance) are considered invariable between the settings. However, this precludes the possibility of accurately measuring arousal in settings where changes in mechanical activity (or basal metabolism, or heat balance) will certainly have an impact on the index of arousal variable (e.g. in sports or other physical activities). Also, such studies are often based on off-line measurements (i.e. before and after induction of arousal). Moreover, there are pitfalls in relying on any single measure of arousal. For example, alerting caused by fear-evoking stimuli causes an increase in heart rate and other autonomic indices. In contrast, phasic alerting caused by orienting toward a nonthreatening stimulus causes a slowing of the heart and other internal organs. Thus there is a need for methods that can specifically monitor the component of the index of arousal that is indicative of actual arousal, independent of physical activity. More particularly, such methods should take into account the complex, individual, time-varying and dynamic character of the individual organism monitored and be suitable for monitoring physical activity related variables and environmental variables as well.

The Figures

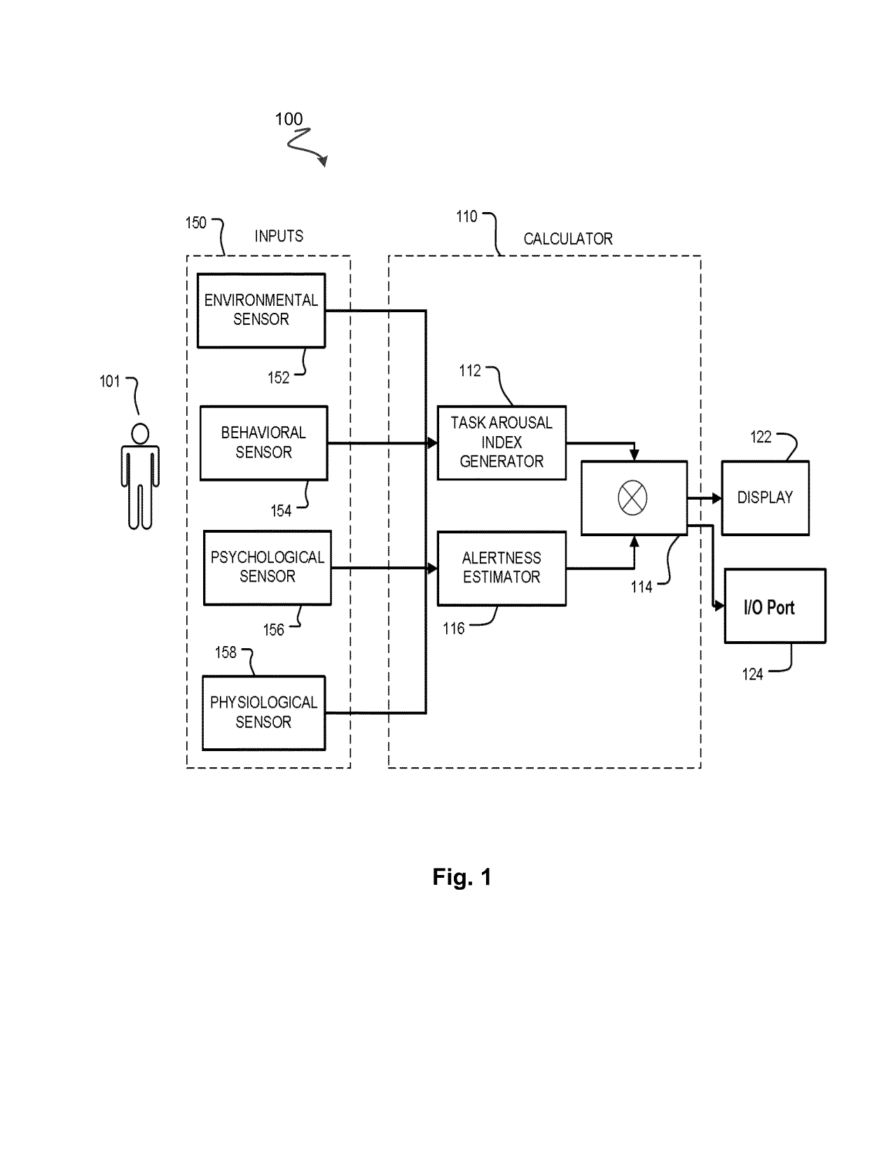

FIG. 1 provides a schematic illustration of a system 100 for system for determining a task-modulated neurobehavioral status estimate, in accordance with particular embodiments. System 100 comprising a computer 110 and an optional input array 150 communicably connected to one another, such that data from optional input array 150 may be received at computer 110. Computer 110 may comprise any device or system capable of carrying out the methods of the presently disclosed invention, whether the methods are run on a microprocessor or other computational device or not. Non-limiting examples of computer 110 may comprise a personal computer, one or more personal computers communicably connected (e.g., by communications cable or over a network, etc.), a client-server network, a portable device (e.g., a personal data assistant, a mobile phone, a tablet computer, etc.), an embedded system specifically designed to carry out the methods of the presently disclosed invention, and/or the like.

Optional input array 150 may comprise one or more of: one or more environmental sensors 152 (or other input means for environmental data), one or more behavioral sensors 154 (or other input means for behavioral data), one or more psychological sensors (or other input means for psychological data) 156, and one or more physiological sensors 158 (or other input means for physiological data). Array 150 may comprise a solitary device or system, or may comprise multiple devices or systems, according to alternative embodiments. Sensors 152, 154, 156, and 158 may comprise any device, system, machine, computer, network, or contraption capable of acquiring appropriate data.

In particular embodiments environmental sensor 152 may comprise one or more (or some combination) of a thermometer, a thermistor, an air pressure gauge, a humidity detector, a light meter, a camera, a microphone, an accelerometer, a wind gauge, and/or the like. In particular embodiments behavioral sensor 154 may comprise one or more (or some combination) of a video camera with (internal or external) frame grabbing and analysis capabilities, a force measurement device (e.g., scale, ergometer, etc.), user input means (for receipt of subjective behavioral data—e.g., distraction level, physical and mental exertion required, etc.). In particular embodiments psychological sensor 156 may comprise one or more (or some combination) of a database of psychological information, user input means (for receipt of subjective psychological data—e.g., mood, anxiety level, etc.). In particular embodiments physiological sensor 158 may comprise one or more (or some combination) of a blood pressure gauge; a hear rate monitor; a heart rate monitor with heart-rate variability measurement capability; EEG/EKG machine, system or device; biorhythm measurement devices, heat balance detectors, perspiration monitors, and/or the like. In particular embodiments one or more of the foregoing or their equivalents may be combined with another to form input array 150. When one or more components are combined to form input array 150, input array 150 may or may not comprise a solitary physical unit, device, or system. According to particular embodiments, input array 150 may comprise multiple devices positioned in different locations, which may or may not be communicably connected to one another.

Computer 110 may further comprise a task arousal index generator 112, an alertness estimator 116, and a modulator unit 114. Task arousal index generator 112 is capable of either receiving a task arousal index (e.g., from I/O port 124) or calculating a task arousal index from data received from one or more of sensors 152, 154, 156, 158. Alertness estimator 116 is capable of either receiving a neurobehavioral status estimate (e.g., from I/O port 124) or calculating one from additional data (e.g., neurobehavioral model input data) received at computer 110 (e.g., through I/O port 124). (Despite its name, alertness estimator 116 may determine any type of neurobehavioral status, not just alertness or fatigue, as described elsewhere herein.) Modulator unit 114 is capable of determining a task-modulated neurobehavioral estimate from the task-arousal index provided by task arousal index generator 112 and the neurobehavioral status estimate provided by alertness estimator 116. One or more of index generator 112, alertness estimator 116, and modulator unit 114 may comprise separate physical components of computer 110 according to particular embodiments. According to other embodiments, computer 110 comprises a microprocessor (not shown) and system software (not shown), such that the system software contains instructions that when executed by the microprocessor cause computer 110 to perform the same functions as index generator 112, alertness estimator 116, and modulator unit 114.

System 100 may also comprise an optional display 122 and an optional communications port 124 (also called a “communicator” or “I/O port”). Optional display 122 may comprise any device or system capable of providing output to a user, including (without limitation) a monitor, an LCD screen, a light or diode array, a speaker, and/or the like. Optional communications port 124 may comprise any communications port capable of sending and receiving information to and from a computer or other electronic device or system as is known in the art.

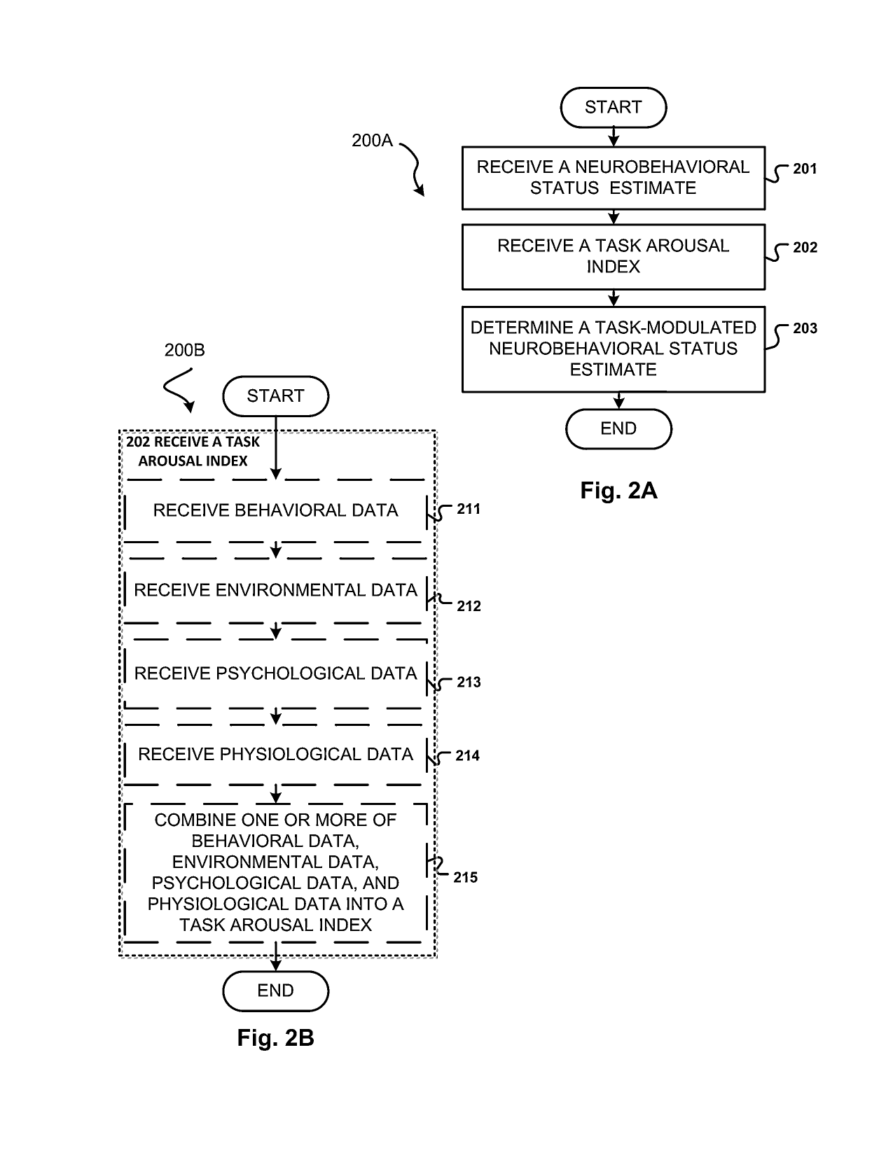

FIG. 2A provides a flow chart for a method 200A for determining a task-modulated neurobehavioral status estimate, in accordance with particular embodiments. Method 200A commences with step 201 wherein a neurobehavioral status estimate is received at computer 110. A step-201 received neruobehavioral status estimate may comprise the output of one or more neurobehavioral performance models (as discussed elsewhere herein), in accordance with particular embodiments. The step-201 received neurobehavioral status estimate may be received from a microprocessor (not shown) integral to computer 110, or may be received as specific input either from another user or another computer, device, or system (e.g., through I/O port 124), according to differing embodiments. For those embodiments wherein the step-201 received neurobehavioral status estimate is determined by a microprocessor integral to computer 110, computer 110 may determine the step-201 received neurobehavioral status estimate based upon applying one or more neurobehavioral performance models (as described elsewhere herein) to data received (e.g., through I/O port 124) by computer 110 representing various inputs to the one or more neurobehavioral performance models, in accordance with particular embodiments.

Method 200A continues in step 202, wherein a task-arousal index is received at computer 110. A step-202 received task-arousal index may comprise any number, metric, index, and/or quantity capable of modifying a neurobehavioral status estimate to account for particular features of a task being performed by the subject to whom the neurobehavioral performance estimate pertains. A step-202 received task-arousal index may be a rating comprising single value on a scale (e.g., a 73 on scale of 0 to 100, a “B” on an academic scale of “A” to “F”, etc.), a precisely determined floating-point number on a scale from 0 to 1 (e.g., 0.012500), an array or combination of such values and floating-point numbers, and/or the like. The step-202 received task-arousal index may represent a percentage the neurobehavioral status estimate may be multiplied be to receive the task-modulated neurobehavioral performance estimate, in accordance with particular embodiments. The step-202 received task-arousal index may represent an offset (a “+” or “−” number) to be applied to the neurobehavioral status estimate to receive the task-modulated neurobehavioral performance estimate, in accordance with particular embodiments. In particular embodiments, the step-202 received task-arousal index varies as a function of time or another independent variable. According to particular embodiments, the step-202 received task arousal index may be determined by data received from one or more of sensors 152, 154, 156, 158. In other embodiments, the step-202 received task arousal index is received from data supplied to I/O port 124 either by user input or from another device, computer, database, system, or network. Step-202 received task arousal index may be an index designated to particular tasks and stored in a database or other computer memory. Step-202 received task arousal index may be provided by one or more methods disclosed herein or through one or more techniques known in the art. Published U.S. patent application no. 2009/0312998 for a “Real-Time Monitoring and Control of Physical and Arousal Status of Individual Organisms,” published Dec. 17, 2009, hereby incorporated by reference herein, discloses techniques for converting measurements of the metabolic energy (or other mobilized energy) of an organism (including a human subject) into a task arousal index (a so-called “estimate of an arousal component of an arousal variable”) capable of being used by the presently disclosed invention.

Method 200A continues in step 203, wherein a task-modulated neurobehavioral status estimate is determined, based at least in part on the step-201 received neurobehavioral performance estimate and the step-202 received task-arousal index. A step-203 determined task-modulated neurobehavioral status estimate may comprise one or more values of a neurobehavioral performance model (as described elsewhere herein), in accordance with particular embodiments. Determining a task-modulated neurobehavioral status estimate according to step 203 may comprise multiplying the step-201 received neurobehavioral status estimate by the combined factor represented by the step-202 received task-arousal index, or it may comprise adding or subtracting from the step-201 received neurobehavioral status the aggregate offset value represented by the step-202 received task-arousal index (see step 215 of method 200B and associated discussion, for more details).

FIG. 2B provides a flow chart for a method 200B for determining a step-202 received a task arousal index, in accordance with particular embodiments in which the step-202 received task arousal index is not provided via user input but rather calculated from data collected by one or more of sensors 152, 154, 156, 158. Method 200B commences with optional step 211, wherein behavioral data is received at computer 110 from behavioral sensor 154. Step-211 received behavioral data may comprise data relating to one or more of body position of the subject, physical exertion required of the designated task, recent physical activity of the subject, level of physical distraction of the subject (e.g., moving objects or other nuisance in the environment affecting the subject's behavior), mental concentration required by the designated task, and/or the like in accordance with particular embodiments.

Method 200B continues with optional step 212, wherein environmental data is received at computer 110. Optional step-212 received environmental data may comprise data relating to one or more of temperature, air pressure, humidity, ambient light level, ambient sound level, vibration of the environment (e.g., a factory floor or a bed of a moving truck), movement of the environment (e.g., a ship or plane), wind condition, and/or the like, in accordance with particular embodiments.

Method 200B continues with optional step 213, wherein psychological data is received at computer 110. Optional step-213 received psychological data may comprise data relating to one or more of mood, mental illness, anxiety, and/or the like, in accordance with particular embodiments.

Method 200B continues with optional step 214, wherein physiological data is received at computer 110. Optional step-214 received physiological data may comprise data relating to one or more of blood pressure data, heart rate data, heart-rate variability data, illness state data, metabolism state data, ECG data, biorhythm data, heat balance data, perspiration rate data, and/or the like, in accordance with particular embodiments.

Method 200B continues with optional step 215, wherein one or more of optional step-211 received behavioral data, optional step-212 received environmental data, optional setp-213 received physiological data, and optional step-214 received are combined into a task-arousal index. Step-215 combined task arousal index may be any task arousal index as specified by step 202 of method 200A. The combination of data from one or more of sensors 152, 154, 156, 158 may take any form as known in the art. One non-limiting method of combining data from sensors 152, 154, 156, 158 comprises reducing each data received to a percentage scale ranging from the lowest value for such a data field to the highest value for such a data field. (For example, temperature data may be reduced to a percentage scale on the assumption that the lowest received temperature is 0° C. and the highest is 100° C., or these outside ranges can be adjusted accordingly.) Another non-limiting method for combining data from sensors 152, 154, 156, 158 is to determine an offset of the data from an ideal value for such data. (For example, the temperature scale can be the difference between the received temperature data from sensor 152 and an agreed-upon normal room temperature.) Once each field of data received from sensors 1523, 154, 156, 158 is reduced to a scaled or offset value, then each such received field of data can be combined into a single datum for use as a step-215 combined task arousal index. Combination into such a single datum may comprise multiplying each scaled data value by one another, by adding or subtracting each offset value from one another, taking an average or weighted average of all such values, and/or the like.

FIG. 3A provides a chart indicating the model-predicted neurobehavioral status of a subject over a 48-hour period, in accordance with particular embodiments. (The particular neurobehavioral status depicted in FIG. 3A is alertness level, although the presently disclosed invention may be applied to any neurobehavioral status type.) Fatigue line 301A shows characteristic increases during wake periods 303 and characteristic decreases during sleep periods 302 (shown shaded). Fatigue line 301 may represent the neurobehavioral performance model predicted values of a subject's alertness or fatigue state over the time interval shown. The neurobehavioral performance model may be any of such models described elsewhere herein, and the output of such models may be correlated to particular neurobehavioral performance assessments (e.g., test metrics). For FIGS. 3A and 3B, it may be assumed that the model used is the two-process model of alertness prediction, and the neurobehavioral performance assessment used for correlation to the model output is the average response time on the PVT.

FIG. 3B provides a chart indicating the model predicted neurobehavioral status of a subject over a 48-hour period, wherein the neurobehavioral status of the testing subject is modulated by a task-arousal index corresponding to a task that the subject is performing during a six (6) hour period indicated by activity period 303C, in accordance with particular embodiments. Activity period 303C represents a time interval in which the subject is performing a task that requires a unique neurobehavioral effort in which to engage (e.g., watching a computer monitor for long hours at night, lifting heavy machinery in a repetitive fashion, night driving, etc.). Fatigue line portions 301B from FIG. 3B are identical to the corresponding portions of fatigue line 301A from FIG. 3A. Fatigue line portion 301C, however, illustrates a noticeable offset in the predicted alertness level corresponding to the presence of a task-modulated fatigue (neurobehavioral performance) estimate for the time interval during which the designated task was being performed.

Certain implementations of the invention comprise computers and/or computer processors which execute software instructions which cause the processors to perform a method of the invention. For example, one or more processors in a system may implement data processing blocks in the methods described herein by executing software instructions retrieved from a program memory accessible to the processors. The invention may also be provided in the form of a program product. The program product may comprise any non-transitory medium which carries a set of computer-readable instructions that, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Certain implementations of the invention may comprise transmission of information across networks, and distributed computational elements which perform one or more methods of the inventions. Such a system may enable a distributed team of operational planners and monitored individuals to utilize the information provided by the invention. A networked system may also allow individuals to utilize a graphical interface, printer, or other display device to receive personal alertness predictions and/or recommended future inputs through a remote computational device. Such a system would advantageously minimize the need for local computational devices.

Certain implementations of the invention may comprise exclusive access to the information by the individual subjects. Other implementations may comprise shared information between the subject's employer, commander, flight surgeon, scheduler, or other supervisor or associate, by government, industry, private organization, and/or the like, or by any other individual given permitted access.

Certain implementations of the invention may comprise the disclosed systems and methods incorporated as part of a larger system to support rostering, monitoring, selecting or otherwise influencing individuals and/or their environments. Information may be transmitted to human users or to other computerized systems.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components that are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
The systems and methods of various embodiments may be extended to include other measures of human performance such as gross-motor strength, dexterity, endurance, or other physical measures. For example, fatigue may be replaced by one or more other types of neurobehavioral performance such as “sleepiness”, “alertness”, “tiredness”, “cognitive performance”, “cognitive throughput”, and/or the like.
Other models or estimation procedures may be included to deal with biologically active agents, external factors, or other identified or as yet unknown factors affecting alertness/fatigue.

What is claimed is:

1. A method for determining with a computer a task-modulated neurobehavioral status estimate based upon a subject's task-independent neurobehavioral status estimate and a task-arousal index, the method comprising:
receiving at the computer a neurobehavioral status estimate, the neurobehavioral status estimate being indicative of the neurobehavioral status of a subject under a set of external conditions irrespective of a task being performed;
determining, at the computer, a task-arousal index, the task-arousal index being indicative of the neurobehavioral impact related to the subject performing a designated task; and
determining a task-modulated neurobehavioral status estimate based at least in part on the received neurobehavioral status estimate and the determined task-arousal index, the task-modulated neurobehavioral status estimate being indicative of the neurobehavioral status of the individual while performing the designated task.

2. A method according to claim 101 further comprising receiving environmental data at the computer, the environmental data being indicative of factors in an environment where a subject is performing an designated task, wherein determining a task-arousal index at the computer is based at least in part on the received environmental data.

3. A method according to claim 101 further comprising receiving behavioral data, the behavioral data being indicative of factors related to the behavior of the subject while performing the designated task, and wherein determining a task-arousal index at the computer comprises determining a task-arousal index based at least in part on the received behavioral data.

4. A method according to claim 101 further comprising receiving psychological data, the psychological data being indicative of the psychological factors of the subject impacted by performing the designated task, and wherein determining a task-arousal index comprises determining a task-arousal index based at least in part on the received psychological data.

5. A method according to claim 101 further comprising receiving physiological data, the physiological data being indicative of the physiological factors impacted by the subject performing the designated task, and wherein determining a task-arousal index comprises determining a task-arousal index based at least in part on the received physiological data.

6. A method according to claim 102 wherein the environmental data comprises data relating to one or more of: temperature, air pressure, humidity, ambient light level, ambient sound level, vibration, movement, and wind condition.

7. A method according to claim 103 wherein the behavioral data comprises data relating to one or more of: body position, physical exertion required of the designated task, recent physical activity of the subject, level of distraction of the subject, and mental concentration required by the designated task.

8. A method according to claim 104 wherein the psychological data comprises data relating to one or more of: mood, mental illness, and anxiety.

9. A method according to claim 105 wherein the physiological data comprises data relating to one or more of: blood pressure data, heart rate data, heart-rate variability data, illness state data, metabolism state data, ECG data, biorhythm data, heat balance data, and perspiration rate data.

10. A method according to claim 101 wherein the received neurobehavioral status estimate is provided by a neurobehavioral performance model.

11. A method according to claim 101 wherein determining the task-arousal index comprises receiving the task-arousal index from one or more of: user input, a computer, a network, a database, and a portable device.

12. A method according to claim 101 wherein determining the task-arousal index comprises:
converting one or more of received environmental data, received behavioral data, received physiological data, and received psychological data to a data-specific index, and
combing each data-specific index converted from the one or more received environmental data, received behavioral data, received physiological data, and received psychological data into a task-arousal index.

13. A method according to claim 111.1, wherein converting one or more of received environmental data, received behavioral data, received physiological data, and received psychological data to a data-specific index comprises scaling the one or more of received environmental data, received behavioral data, received physiological data, and received psychological data into a scaled factor with respect to a lowest and highest value for each received data.

14. A method according to claim 111.1, wherein converting one or more of received environmental data, received behavioral data, received physiological data, and received psychological data to a data-specific index comprises determining an offset for each of the one or more of received environmental data, received behavioral data, received physiological data, and received psychological data into a scaled factor with respect to an ideal value for each received data.

15. A method according to claim 111.2 wherein determining the task-arousal index comprises determining a factor comprising multiplying together each scaled factor scaled from each of the one or more received environmental data, received behavioral data, received physiological data, and received psychological data.

16. A method according to claim 111.2 wherein determining the task-arousal index comprises determining a combined offset by adding or subtracting each determined offset from each of the one or more received environmental data, received behavioral data, received physiological data, and received psychological data.

17. A method according to claim 111.3 wherein the neurobehavioral status estimate is determined by multiplying the received neurobehavioral status estimate by the determined factor.

18. A method according to claim 111.3 wherein the neurobehavioral status estimate is determined by adding or subtracting the combined offset from the received neurobehavioral status estimate.

19. A computer program product embodied in a non-transitory medium and comprising computer-readable instructions that, when executed by a suitable computer, cause the computer to perform a method for determining a task-modulated neurobehavioral status estimate based upon a subject's task-independent neurobehavioral status estimate and a task-arousal index, the method comprising:
receiving at the computer a neurobehavioral status estimate, the neurobehavioral status estimate being indicative of the neurobehavioral status of a subject under a set of external conditions irrespective of a task being performed;
determining, at the computer, a task-arousal index, the task-arousal index being indicative of the neurobehavioral impact related to the subject performing a designated task; and
determining a task-modulated neurobehavioral status estimate based at least in part on the received neurobehavioral status estimate and the determined task-arousal index, the task-modulated neurobehavioral status estimate being indicative of the neurobehavioral status of the individual while performing the designated task.
